(19) United States
(12) Patent Application Publication
(10) Pub. No.: US 2026/0179830 A1
(43) Pub. Date: Jun. 25, 2026

(54) A BOBBIN FOR WINDING AN OPTICAL FIBER THEREON

(71) Applicant: HFCL Limited, Greater Kailash II (IN)

(72) Inventors: Abhijeet Pratap Shahapure, Maheshwaram Mandal (IN); Dhruv Soni, Maheshwaram Mandal (IN)

(73) Assignee: HFCL Limited, Greater Kailash II, DL (IN)

(21) Appl. No.: 19/126,884

(22) PCT Filed: Aug. 23, 2024
(86) PCT No.: PCT/IN2024/051540

§ 371 Date: May 2, 2025

(30) Foreign Application Priority Data
Aug. 23, 2023 (IN) 202311056551

(51) Int. Cl. H01F 27/32

(52) U.S. Cl. CPC H01F 27/325

(57) ABSTRACT

Described herein is a bobbin [200] for winding an optical fiber thereon The bobbin [200] comprises: at least one side plate [102] installed on an end thereof, to define a secondary optical fiber winding region [200b] around a periphery thereof; a cylindrical portion [202] defining a primary optical fiber winding region [200b]; and a first and second disc-shaped flange portions [204, 206] on either ends thereof. At least one of the first and second disc-shaped flange portions [204, 206] defines a through-slot [210] for routing the optical fiber from the primary optical fiber winding region [200a] to the secondary primary winding region [200b], and a curved support section [212] defined below the through-slot [210], and having a convex structure coaxial to the secondary optical fiber winding region [200b], for smoothly guiding the optical fiber from the through-slot [210] onto the secondary optical fiber winding region [200b].

### TECHNICAL FIELD

The present disclosure relates to spools employed for winding optical fibers, and more particularly, to a bobbin for winding an optical fiber thereon.

### BACKGROUND OF THE INVENTION

This section is intended to provide information relating to the field of the invention and thus, any approach or functionality described below should not be assumed to be qualified as prior art merely by its inclusion in this section.

Bobbins, also known as spools, are commonly known in the field of optical fibers. After manufacturing, the optical fiber is typically wound on bobbins for storage, shipping and subsequent processing such as optical fiber coloring, coating, ribboning, cable manufacturing, testing, and other similar operations performed on the optical fibers. Typically, a bobbin employs at least a side plate attached on to an end thereof, to thereby define a secondary optical fiber winding region. The secondary winding region is adapted to wind the excess optical fiber thereon, to allow the ends of the optical fiber to be accessible for testing purposes. Further, a bobbin cover unit may also be employed to house and rotatably support the bobbin therein. The structure and arrangement of the at least one side plate and the bobbin cover unit is commonly known to a person skilled in the art, and therefore, is not described herein for the sake of brevity.

Conventionally, the bobbin defines a cylindrical portion, a first flange portion, and a second flange portion. Each of the first and second flange portions extend radially outwards from either end of the cylindrical portion, to define a primary optical fiber winding region therebetween. Further, at least one of the first and second flange portions define a through-slot for guiding the excess optical fiber from the primary optical fiber winding region to the secondary optical fiber winding region.

However, during high-speed winding and unwinding operations, the first and second flange portions of the conventional bobbin are prone to undergo some degree of deformation due to a number of stresses acting thereon. Such a deformation, irrespective of its extent, causes improper readings of end points of the first and second flange portions of the conventional bobbin. As a result, this further leads to substantial errors or defects in winding operations of the optical fiber, which results in micro-bending as well macro-bending losses, even in some cases physical damage to the optical fiber. Additionally, there exists yet another high priority concern i.e., abrupt bending of the optical fiber at the through-slot of the conventional bobbin, during guiding of the optical fiber to the secondary optical fiber winding region therefrom. Such an abrupt bending of the optical fiber may cause an abrupt increase in attenuation at the point of bend, which may be referred to as a step loss. In particular, the severity of such a step loss is dependent on the degree of bending of the optical fiber and the radius of curvature of the bend. In addition to the above, there may also arise a plurality of scattering and micro-bending effects across a length of the optical fiber, due to the aforementioned abrupt bending thereof.

Accordingly, in view of the aforementioned limitations and various other drawbacks inherent in the art, there exists a well felt need to provide a durable, cost-efficient, high-speed rated, and improved bobbin for winding of the optical fiber thereon, which the present disclosure aims to address.

### SUMMARY OF THE INVENTION

This section is intended to introduce certain aspects of the disclosed system in a simplified form and is not intended to identify the key advantages or features of the present disclosure.

The present disclosure relates to a bobbin for winding an optical fiber thereon. The bobbin comprises at least one side plate attached on to an end of the bobbin, to define a secondary optical fiber winding region around a periphery thereof; a cylindrical portion defining a first end, a second end, and a primary optical fiber winding region therebetween; and a first disc-shaped flange portion and a second disc-shaped flange portion extending radially outwards from the first and second ends of the cylindrical portion, respectively. Particularly, at least one of the first and second disc-shaped flange portions defines: an array of ribs extending from an outer surface thereof; a through-slot adapted to route an excess optical fiber from the primary optical fiber winding region to the secondary optical fiber winding region, for winding the same thereon; and a curved support section defined below the through-slot. Notably, the curved support section has a convex structure coaxial to the secondary optical fiber winding region, such that the curved support section is capable of smoothly guiding the optical fiber from the through-slot onto the secondary optical fiber winding region.

According to an aspect of the present disclosure, the curved support section has a varying thickness, such that the thickness of the curved support section is minimum at a base end thereof, and maximum at a cantilever end thereof.

According to another aspect of the present disclosure, the winding capacity of the bobbin ranges between 50 km to 100 km.

According to yet another aspect of the present disclosure, the array of ribs includes a first set of ribs defined radially on at least one of the first and second disc-shaped flange portions, and a second set of ribs defined circumferentially on at least one of the first and second disc-shaped flange portions, to provide flexural strength to the bobbin without significantly increasing the overall weight of the bobbin.

According to yet another aspect of the present disclosure, each of the first set of ribs and the other of the first set of ribs adjacent thereto, are separated by an angle ranging between 3 and 10 degrees.

According to yet another aspect of the present disclosure, one or more of the first set of ribs and one or more of the second set of ribs, in combination, defines the through-slot.

According to yet another aspect of the present disclosure, the cylindrical portion includes: an inner cylindrical section adapted to be connected to a rotary spindle, to facilitate high-speed rotation of the bobbin at a speed of at least 3000 rpm; an outer cylindrical section coaxial relative to the inner cylindrical section, the outer cylindrical section defining the primary optical fiber winding region thereon; and one or more radial vanes extending radially between the inner and outer cylindrical sections. Notably, one or more radial vanes are adapted to facilitate attachment of each of the first and second disc-shaped flange portions to the first and second ends of the cylindrical portion of the bobbin, respectively.

According to yet another aspect of the present disclosure, at least one of the first and second disc-shaped flange portions define a locking provision for locking or fixing at least one end of the optical fiber wound on the bobbin.

According to yet another aspect of the present disclosure, the bobbin is adapted to be housed and supported within a bobbin cover unit.

According to yet another aspect of the present disclosure, the through-slot is defined on at least one of the first and second disc-shaped flange portions for providing an ingress protection to the primary optical fiber winding region of the bobbin against extraneous matter being one of fluid and dust.

According to yet another aspect of the present disclosure, each of the first and second disc-shaped flange portions have a minimum mass at a central portion thereof, and a maximum mass at an outer portion thereof, to provide structural rigidity to the bobbin and stability during high-speed rotation.

### BRIEF DESCRIPTION OF DRAWINGS

In order to explain the technical solution in the embodiments of the present application more clearly, the drawings used in the description of the embodiments will be briefly introduced below. It is obvious that the drawings in the following description are only some embodiments of the application. For those skilled in the art, without any creative work, other drawings can be obtained based on these drawings.

FIG. 1 illustrates a perspective view of an arrangement of a bobbin and a bobbin cover unit, in accordance with the concepts of the present disclosure.

FIG. 2 illustrates a first perspective view of the bobbin, in accordance with the concepts of the present disclosure.

FIG. 3 illustrates a side view of the bobbin of FIG. 2, in accordance with the concepts of the present disclosure.

FIG. 4 illustrates a second perspective view of the bobbin of FIG. 2, in accordance with the concepts of the present disclosure.

FIG. 5 illustrates graphical representations of attenuation in an optical fiber wound on bobbin of the prior art.

FIG. 6 illustrates a graphical representation of attenuation in the optical fiber wound on the bobbin, in accordance with the concepts of the present disclosure.

### DETAILED DESCRIPTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only one of the problems discussed above. Some of the problems discussed above might not be fully addressed by any of the features described herein. Exemplified embodiments of the present invention are described below, as illustrated in various drawings in which like reference numerals refer to the same parts throughout the different drawings.

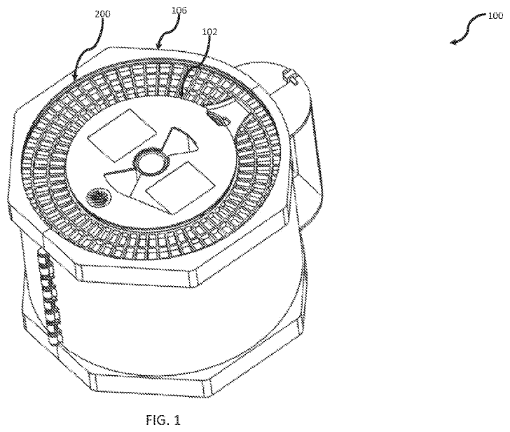

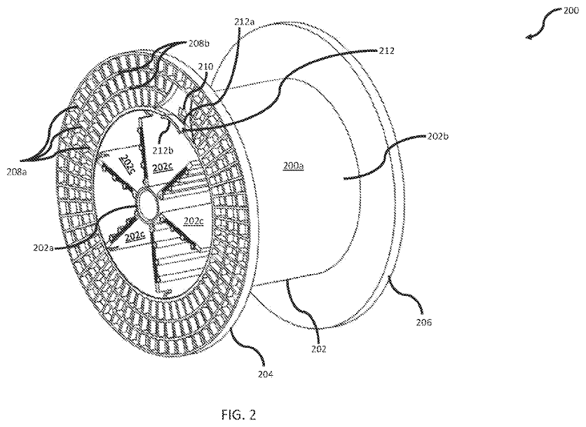

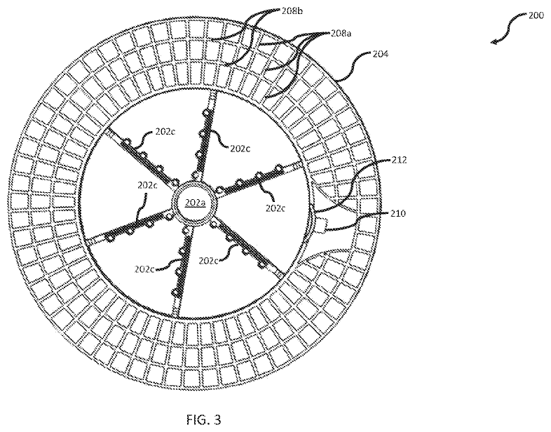

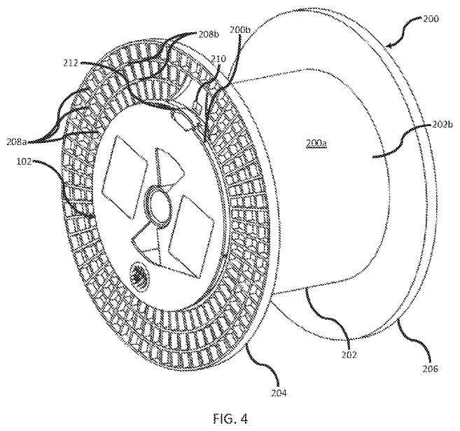

FIG. 1 illustrates a perspective view of an arrangement of a bobbin [200] and a bobbin cover unit [106], in accordance with the concepts of the present disclosure. FIG. 2 illustrates a first perspective view of the bobbin [200], in accordance with the concepts of the present disclosure. FIG. 3 illustrates a side view of the bobbin [200] of FIG. 2, in accordance with the concepts of the present disclosure. FIG. 4 illustrates a second perspective view of the bobbin [200] of FIG. 2, in accordance with the concepts of the present disclosure. FIG. 1 to 4 may be referred to in conjunction with each other, in order to better understand the concepts of the present disclosure.

Referring to FIG. 1, there is shown the bobbin [200], which is housed and supported within a bobbin cover unit [106], after completion of winding operations performed thereon. The bobbin [200] comprises at least one side plate [102], wherein the at least one side plate [102] is attached on to an end of the bobbin [200], to thereby define a secondary optical fiber winding region [200b] around a periphery thereof. In an alternate embodiment, the at least one side plate [102] can be integrated with the bobbin [200] so as to form a unary component defining both, the primary optical fiber winding region [200a] and the secondary optical fiber winding region [200b]. Such a bobbin [200], having an integrated at least one side plate [102], may be formed by employing a molding process. Particularly, the bobbin cover unit [106] is adapted to ensure easy handling and protection of the bobbin [200] and the optical fiber wound thereon from damage, which may be caused due to any extraneous matter such as, but not limited to, fluid and dust. In an embodiment, the weight of the bobbin cover unit [106] is approximately 150 grams. The structure and arrangement of the bobbin cover unit are obvious to a person skilled in the art, and therefore, not repeated herein for the sake of brevity. In an exemplary embodiment, acrylonitrile butadiene styrene (ABS) thermoplastic polymer is used as a material for each of the bobbin [200], the at least one side plate [102], and the bobbin cover unit [106]. In another embodiment, each of the abovementioned components can be made of different thermoplastic materials.

As seen from FIGS. 2 and 3 in conjunction with each other, the bobbin [200] further comprises a cylindrical portion [202], a first disc-shaped flange portion [204], and a second disc-shaped flange portion [206]. The cylindrical portion [202] defines a first end, a second end, and a primary optical fiber winding region [200a] between the first and second ends. In an embodiment, the primary optical fiber winding region [200a] comprises a cushioning layer to reduce stress and prevent damage to the optical fiber during winding and unwinding operations. Notably, the primary optical fiber winding region [200a] of the bobbin [200] provides for a wide range of winding capacity i.e., 50 kms and above. In an embodiment, the bobbin [200] can support winding capacity up to 100 kms. The term ‘winding capacity’ refers to the length of the optical fiber capable of being wound on the bobbin [200] without impacting the performance of bobbin [200]. The winding capacity of the bobbin [200] may vary based on the dimension of the bobbin [200] as well as the outer diameter of the optical fiber being wound thereon.

The cylindrical portion [202] includes an inner cylindrical section [202a], an outer cylindrical section [202b], and one or more radial vanes [202c]. The inner cylindrical section [202a] adapted to be connected to a rotary spindle, to allow high-speed rotation of the bobbin [202] at a speed of at least 3000 rpm. The outer cylindrical section [202b] is coaxial relative to the inner cylindrical section [202a] and defines the primary optical fiber winding region [200a] thereon. The one or more radial vanes [202c] extend radially between the inner and outer cylindrical sections [202a, 202b]. Further, the judicial deployment of one or more radial vanes [202c] between the inner cylindrical section [200a] and the outer cylindrical section [200b], provides additional flexural strength to the bobbin [200] without significantly increasing the overall weight of the bobbin [200]. Notably, the inner cylindrical section [202a], the one or more radial vanes [202c], and the outer cylindrical section [202b] continuously form the cylindrical portion [202].

Now referring to FIG. 4, the first and second disc-shaped flange portions [204, 206] extend radially outwards from the first and second ends of the cylindrical portion [202], respectively. Notably, in an exemplary embodiment, each of the first and second disc-shaped flange portions [204, 206] has a thickness of at least 10 mm. Particularly, the overall weight of the bobbin [200] is ensured to be controlled by judicially controlling the mass of each of the first and second disc-shaped flange portions [204, 206]. More particularly, the mass at a central portion of each of the first and second disc-shaped flange portions [204, 206] is minimum, while the mass at an outer portion of each of the first and second disc-shaped flange portions [204, 206] is maximum, in order to ensure superior rigidity of the bobbin [200]. Further, a height of each of the first and second disc-shaped flange portions [204, 206] is maintained while considering ratio of length to diameter of the optical fiber to be wound, in order to achieve winding of the optical fiber having up to 50 kms of length.

At least one of the first and second disc-shaped flange portions [204, 206] defines an array of ribs [208], a through-slot [210], and a curved support section [212]. The array of ribs [208] extends from an outer surface of at least one of the first and second disc-shaped flange portions [204, 206]. In an exemplary embodiment, the array of ribs [208] has at least 60 ribs, to provide flexural strength to the at least one of the first and second disc-shaped flange portions [204, 206].

In particular, as seen from FIG. 2, the array of ribs [208] includes a first set of ribs [208a] and a second set of ribs [208b]. More particularly, the first set of ribs [208a] is defined radially on at least one of the first and second disc-shaped flange portions [204, 206], while the second set of ribs [208b] is defined circumferentially on at least one of the first and second disc-shaped flange portions [204, 206]. In an embodiment, the arrangement of the first and second set of ribs [208a, 208b] on the first disc-shaped flange portion [204] is different from the arrangement of the first and second set of ribs [208a, 208b] on the second disc-shaped flange portion [206]. In an embodiment, each of the first and second set of ribs [208a] extend orthogonally/laterally from an outer surface of at least one of the first and second disc-shaped flange portions [204, 206]. In another embodiment, each of the first and second set of ribs [208a] extend at an inclination angle relative to an outer surface of at least one of the first and second disc-shaped flange portions [204, 206]. In such an embodiment, the inclination angle is below 90 degrees. In yet another embodiment, each of the first and second set of ribs [208a] can have a varying thickness. In still another embodiment, each of the first and second set of ribs [208a] can have a uniform thickness.

A person skilled in art would appreciate that during winding of the optical fiber on the bobbin, a uniform gap, also known as binding pitch, is maintained between adjacently subsequent winding of optical fiber, wherein the binding pitch is less than the diameter of the optical fiber. Optical fiber of subsequent layer is wound in such a manner that each winding of optical fiber of subsequent layer is at least partially wound between the binding pitch of the optical fiber of the previous layer. This helps in reducing the stress acting on the optical fiber wound on the bobbin, since optical fiber has a very thin diameter, typically, in a range of 160 micrometers to 250 micrometers. Maintaining gaps with such precision during high-speed rotation highly depends on the stability of the bobbin. Thus, judicial design of the bobbin [200], in accordance with present invention, provides structural rigidity and stability for high-speed rotation with capability to accommodate a large length of optical fiber in a range of 50 to 100 km.

Advantageously, the first set of ribs [208a] and the second set of ribs [208b], in combination, provide superior flexural strength to the bobbin [200], thereby ensuring accurate readings of end points of the first and second disc-shaped flange portions [204, 206], in order to achieve error-free or defect-free winding of the optical fiber. At least by virtue of the aforementioned, the bobbin [200] of the present invention proves to address the limitation of the conventional bobbin. Upon an experimental comparison of high-speed winding operations on the bobbin [200] of the present invention with the existing bobbin, the bobbin [200] proved to demonstrate no physical defects in the optical fiber due to bad winding. The experimentation data analyzed 200 lots of conventional bobbin and bobbin [200], as per present invention, and it was observed that conventional bobbins had defects in at least 2.3% cases. However, no such defects were observed in bobbin [200] of the present invention.

Further, each of the first set of ribs [208a] and the other of the first set of ribs [208a] adjacent thereto, are separated by an angle ranging between 4 and 8 degrees. In other words, the angle between every two subsequent ribs of the first set of ribs [208a] ranges from 4 degrees to 8 degrees. Preferably, the aforementioned angle is kept at 6 degrees, which experimentally proves to be the most optimal for enabling the bobbin [200] to withstand high strength without significant increase in weight. However, the aforementioned may not be construed so as to limit the scope of the present disclosure. In an embodiment, each of the first set of ribs [208a] are uniformly distributed across the first and second disc-shaped flange portions [204, 206]. In another embodiment one or more pair of adjacent ribs of the first set of ribs [208a] are spaced apart with different angles which may vary in the range of 4 to 8 degrees. Those skilled in the art may envision other forms, numbers, and positioning of the array of ribs [208] across at least one of the first and second disc-shaped flange portions [204, 206], and the same lies within the scope of the present disclosure. In the preferred embodiment, the second set of ribs [208b] comprises at least four ring-shaped ribs, namely, an inner ring-shaped rib, an outer ring-shaped rib, and a first and second intermediate ring-shaped ribs defined therebetween. In an embodiment, the ring-shaped ribs are spaced at equal gaps. In another embodiment gap between subsequent ring-shaped ribs is reduced to increase mass at the outer edge of the flange. Particularly, each of the inner ring-shaped rib, the outer ring-shaped rib, and the first and second intermediate ring-shaped ribs are coaxially defined on at least one of the first and second disc-shaped flange portions [204, 206]. In an exemplary embodiment, the inner ring-shaped rib and the first intermediate ring-shaped rib are separated by a gap of at least 15 mm, while the first intermediate ring-shaped rib and the second intermediate ring-shaped rib are separated by a gap of at least 13.5 mm, and the second intermediate ring-shaped rib and the outer ring-shaped rib are separated by a gap of at least 12.25 mm. In an embodiment, the thickness of the inner ring-shaped rib is minimum, while the thickness of the outer ring-shaped rib is maximum. In such an embodiment, the thickness of each of the ring-shaped rib increases, from the inner ring-shaped rib to the outer ring-shaped rib.

It is to be noted that the dimension of the first and second set of ribs [208a, 208b] and relative positioning thereof is chosen such that the weight of the bobbin [200] and flexural modulus thereof is optimized to enable a smoother high-speed winding operations thereon, while improving the overall winding capacity of the bobbin [200]. The judicial placement of the first and second set of ribs [208a, 208b] on the first and second disc-shaped flange portions [204, 206] reduces the overall weight of the bobbin [200], thereby reducing a load on a machine used to wind the optical fiber, while ensuring intact structural integrity and flexural strength of the bobbin [200]. The thickness of each of the first and second set of ribs [208a, 208b] ranges between 1 mm to 3 mm. In the preferred embodiment, the thickness of each of the first and second set of ribs [208a, 208b] is 2 mm.

In the preferred embodiment of the present invention, the through-slot [210] extends through at least one of the first and second disc-shaped flange portions [204, 206]. The through-slot [210] is adapted to route excess optical fiber from the primary optical fiber winding region [200a] to the secondary optical fiber winding region [200b], for winding the same thereon. In an alternate embodiment, one or more of the first set of ribs [208a] and one or more of the second set of ribs [208b], in combination, defines the through-slot [210]. Such an exemplary embodiment is not represented in the accompanying figures, however, the same may be contemplated by those skilled in the art. In the preferred embodiment, the through-slot [210] can be an inclined slot, for efficiently route the optical fiber, thereby avoiding abrupt bending of the optical fiber. In an exemplary embodiment, the through-slot [210] is an orthogonally/laterally extending slot. In an embodiment, the through-slot [210] has a width of 10 mm. Those skilled in the art may appreciate that the through-slot [210] may also have a width either less or more than 10 mm, and the same lies within the scope of the present disclosure.

In an embodiment, the bobbin cover unit [106] defines a first flange receiving provision and a second flange receiving provision, wherein each of the first and second flange receiving provisions are adapted to snugly receive the first and second disc-shaped flange portions [204, 206] of the bobbin [200], for hermetically housing the bobbin [200] therein. By virtue of such an arrangement, the bobbin cover unit [106] provides an ingress protection to the optical fiber wound around the bobbin [200], against any extraneous matter such as, but not limited to fluid and dust.

The curved support section [212] is defined adjacent to the through-slot [210] and proximal thereto. In particular, the curved support section [212] has a convex structure, as illustrated in FIG. 4, coaxial to the secondary optical fiber winding region [200b], such that the curved support section [212] is capable of smoothly guiding the optical fiber from the through-slot [210] onto the secondary optical fiber winding region [200b]. In the preferred embodiment, the curved support section [212] has a varying thickness, such that the thickness of the curved support section [212] is minimum (i.e., 2.4 mm) at a base end [212a] thereof, and maximum (i.e., 4 mm) at a cantilever end [212b] thereof. In an alternate embodiment, the curved support section [212] has a uniform thickness from the base end [212a] to the cantilever end [212b] thereof. In yet another implementation, the curved support section [212] has a maximum thickness at the central region thereof, and a minimum thickness at the base end [212a] and the cantilever end [212b]. Other alternate embodiments may be envisioned by the person skilled in the art in light of the aforementioned concepts. In an embodiment, the curved support section [212] may extend up to 28 mm from at least one of the first and second disc-shaped flange portions [204, 206]. In an embodiment, the radius of curvature of the curved support section [212] is 24 mm. In an embodiment, the convex structure of the curved support section [212] has an arc angle of 67 degrees. The abovementioned embodiments are merely illustrative and not exhaustive, and those skilled in the art may envision alternate embodiments in light of the same.

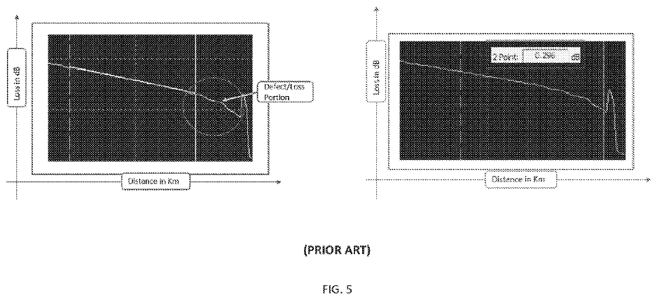

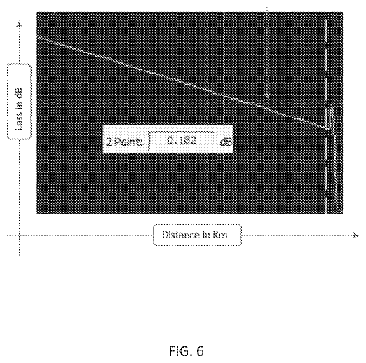

FIG. 5 illustrates graphical representations of attenuation in an optical fiber wound on bobbin of the prior art. FIG. 6 illustrates a graphical representation of attenuation in the optical fiber wound on the bobbin [200], in accordance with the concepts of the present disclosure. FIGS. 5 and 6 are to be viewed in conjunction with each other, in order to better understand the concepts of the present disclosure. For the purposes of current experimentation, the optical fiber wound on both the conventional bobbin and the bobbin [200] is G652D fiber. However, a person skilled in art would appreciate that any category of optical fiber wound on the conventional bobbin and the bobbin [200] will get similar comparative results. Upon the experimental comparison of an exemplary bobbin [200] and the existing bobbin, it is observed that the existing bobbin suffered from a point-to-point loss of at least 0.296 dB (decibel), as seen from FIG. 5. However, the bobbin [200] of the present invention, by virtue of the curved support section [212], shows a substantively reduced point-to-point loss of merely 0.182 dB, as seen from FIG. 6.

In addition to the above, at least one of the first and second disc-shaped flange portions [204, 206] further defines a locking provision (not shown) for locking/fixing at least one end of the optical fiber, which is wound on the bobbin [200]. In light of the above-described embodiments of the present disclosure, those skilled in the art may contemplate further embodiments of the present invention, comprising one or more of the above disclosed features of the present invention. It may be noted that any such combination or alteration of the embodiments of the present invention disclosed above lies well within the scope of the present disclosure.

In operation, an initial end of the optical fiber is routed from the primary optical fiber winding region [200a] to the secondary optical fiber winding region [200b] via the through-slot [200a], and wound on the secondary optical fiber winding region [200b] for a few windings (e.g. 10 to 20 windings). Thereafter, the remaining length of the optical fiber is wound on the primary optical fiber winding region [200a]. After the desired length is wound on the primary optical fiber winding region [200a], the other end of the optical fiber is fixed in locking provision to avoid unwinding of the optical fiber. Thus, during testing, one end of the optical fiber is accessible at the secondary optical fiber winding region [200b], while the other end thereof is accessible at the locking provision of the bobbin [200].

Various advantages of the bobbin [200], as disclosed in the present invention, exist. One such advantage is enhanced flexural strength of the bobbin [200], by virtue of the first and second set of ribs [208a, 208b] defined on at least one or both of the first and second disc-shaped flange portions [204, 206]. Further, in addition to the above, the one or more radial vanes [202c] provided within the outer cylindrical section [202b] minimize the overall material of bobbin [200], while maintaining the flexural strength thereof. Such a structure enables the bobbin [200] to be employed for high-speed winding applications, and simultaneously enhances the durability of the bobbin [200]. In an embodiment, the bobbin [200] can support a winding speed of at least 3000 mpm (meters per minute). In a preferred embodiment, the bobbin [200] supports the winding speed up to 5000 mpm. The overall weight of the bobbin [200] is maintained around 1.25 kg, while optimizing overall dimensions of each of the array of ribs [208], the curved support section [212], the first and second disc-shaped flange portions [204, 206], and other ancillary portions/sections of the bobbin [200].

Furthermore, during such high-speed winding applications, the deformation at the first and second disc-shaped flange portions [204, 206] of the bobbin [200] proves to be negligible, and thus, the bobbin [200] facilitates an error-free or defect-free winding of the optical fiber thereon. In addition to the above, the judicial placement of the curved support section [212] proximal to the through-slot [210] ensures a bend-free guiding of the optical fiber from the through-slot [210] on to the second optical fiber winding region [200b]. Thus, the present invention also eliminates abrupt bending of the optical fiber which occurs in the existing bobbin, thereby reducing bending losses such as, but not limited to a step loss at the point of bending of the optical fiber, and a plurality of scattering and micro-bending losses across the length of the optical fiber. The above-listed advantages are merely illustrative and not exhaustive. Those skilled in the art may envision additional advantages not described hereinabove, in light of the concepts of the present disclosure.

While the preferred embodiments of the present invention have been described hereinabove, it should be understood that various changes, adaptations, and modifications may be made therein without departing from the spirit of the invention and the It will be obvious to a person skilled in the art that the present invention may be embodied in other specific forms without departing from its spirit or essential characteristics. The described embodiments are to be considered in all respects only as illustrative and not restrictive.

### LIST OF COMPONENTS

102—Side plate
106—Bobbin cover unit
200—Bobbin
200a—Primary optical fiber winding region
200b—Secondary optical fiber winding region
202—Cylindrical portion
202a—Inner cylindrical section
202b—Outer cylindrical section
202c—Radial vanes
204—First disc-shaped flange portion
206—Second disc-shaped flange portion
208—Array of ribs
208a—First set of ribs
208b—Second set of ribs
210—Through-slot
212—Curved support section
212a—Base end
212b—Cantilever end

1. A bobbin [200] for winding an optical fiber thereon, the bobbin [200] comprising:
at least one side plate [102] attached on to an end of the bobbin [200], to define a secondary optical fiber winding region [200b] around a periphery thereof;
a cylindrical portion [202] defining a first end, a second end, and a primary optical fiber winding region [200a] therebetween; and
a first disc-shaped flange portion [204] and a second disc-shaped flange portion [206], extending radially outwards from the first and second ends of the cylindrical portion [202], respectively, at least one of the first and second disc-shaped flange portions [204, 206] defining:
an array of ribs [208] extending from an outer surface thereof;
a through-slot [210] adapted to route the optical fiber from the primary optical fiber winding region [200a] to the secondary optical fiber winding region [200b], for winding the same thereon; and
a curved support section [212] defined adjacent to the through-slot [210],
wherein the curved support section [212] is capable of smoothly guiding the optical fiber from the through-slot [210] onto the secondary optical fiber winding region [200b].

2. The bobbin [200] as claimed in claim 1, wherein the curved support section [212] has a concave structure coaxial to secondary winding region and a varying thickness, such that the thickness of the curved support section [212] is minimum at a base end [212a] thereof, and maximum at a cantilever end [212b] thereof.

3. The bobbin [200] as claimed in claim 1, wherein a winding capacity of the bobbin [200] ranges between 50 km to 100 km.

4. The bobbin [200] as claimed in claim 1, wherein the array of ribs [208] includes a first set of ribs [208a] defined radially on at least one of the first and second disc-shaped flange portions [204, 206], and a second set of ribs [208b] defined circumferentially on at least one of the first and second disc-shaped flange portions [204, 206], to provide flexural strength to the bobbin [200].

5. The bobbin [200] as claimed in claim 4, wherein each of the first set of ribs [208a] and the other of the first set of ribs [208a] adjacent thereto, are separated by an angle ranging between 4 and 8 degrees.

6. The bobbin [200] as claimed in claim 1, wherein one or more of the first set of ribs [208a] and one or more of the second set of ribs [208b], in combination, defines the through-slot [210].

7. The bobbin [200] as claimed in claim 1, wherein the cylindrical portion [202] includes:
an inner cylindrical section [202a] adapted to be connected to a rotary spindle, to facilitate high-speed rotation of the bobbin [200] at a speed of at least 3000 rpm;
an outer cylindrical section [202b] coaxial relative to the inner cylindrical section, the outer cylindrical section [202b] defining the primary optical fiber winding region [200a] thereon; and
one or more radial vanes [202c] extending radially between the inner and outer cylindrical sections [202a, 202b],
wherein one or more radial vanes [202c] provides additional flexural strength to the bobbin [200].

8. The bobbin [200] as claimed in claim 1, wherein at least one of the first and second disc-shaped flange portions [204, 206] define a locking provision for locking at least one end of the optical fiber wound on the bobbin [200].

9. The bobbin [200] as claimed in claim 1, wherein the bobbin [200] is adapted to be housed and supported within a bobbin cover unit [106].

10. The bobbin [200] as claimed in claim 9, wherein the bobbin cover unit [106] defines a first flange receiving provision and a second flange receiving provision, wherein each of the first and second flange receiving provisions are adapted to snugly engage with the first and second disc-shaped flange portions [204, 206] of the bobbin [200], for hermetically housing the bobbin [200] therein.

11. The bobbin [200] as claimed in claim 1, wherein each of the first and second disc-shaped flange portions [204, 206] have a minimum mass at a central portion thereof, and a maximum mass at an outer portion thereof, to provide structural rigidity to the bobbin [200].
